(19) United States
(12) Patent Application Publication
(10) Pub. No.: US 2026/0018724 A1
(43) Pub. Date: Jan. 15, 2026

(54) BATTERY PACK STORAGE CASE

(71) Applicant: TOYOTA JIDOSHA KABUSHIKI KAISHA, Toyota-shi (JP)

(72) Inventor: Toshio UCHIYAMA, Toyota-shi (JP)

(73) Assignee: TOYOTA JIDOSHA KABUSHIKI KAISHA, Toyota-shi (JP)

(21) Appl. No.: 19/075,038

(22) Filed: Mar. 10, 2025

(30) Foreign Application Priority Data
Jul. 10, 2024 (JP) 2024-111118

(51) Int. Cl. H01M 50/24; H01M 50/204; H01M 50/262; H01M 50/271

(52) U.S. Cl. CPC H01M 50/24; H01M 50/204; H01M 50/262; H01M 50/271

(57) ABSTRACT

A battery pack storage case includes a battery pack in which a battery module is stored inside a battery pack cover, an outer cover storing the battery pack inside the outer cover, a flange provided outside the battery pack cover, and a flying object protection frame provided inside the outer cover. The flying object protection frame is provided outside the flange and at a different height from the flange.

### CROSS-REFERENCE TO RELATED APPLICATION

This application claims priority to Japanese Patent Application No. 2024-111118 filed on Jul. 10, 2024. The disclosure of the above-identified application, including the specification, drawings, and claims, is incorporated by reference herein in its entirety.

### BACKGROUND

### 1. Technical Field

The present disclosure relates to a battery pack storage case.

### 2. Description of Related Art

Japanese Unexamined Patent Application Publication No. 2018-113153 (JP 2018-113153 A) describes a battery pack that can be mounted on a vehicle. The battery pack includes a front frame, a rear frame, and extensions that connect them, and a protrusion. As a crushable zone, the protrusion receives an impact from the rear of the vehicle and transmits the impact toward the front frame via the extensions, thereby reducing damage to the inside of the battery.

### SUMMARY

However, when a storage battery unit is placed in an outdoor environment, strong winds or the like may cause flying objects to collide with the storage battery unit, resulting in unexpected damage. The battery pack in JP 2018-113153 A has such a structure that the lower part of the battery case is fastened to the vehicle. Therefore, there is an issue that the structure is effective when an impact load is applied to the lower part of the battery case, but less effective when the impact load is applied to the upper part of the battery case.

A battery pack storage case according to an embodiment includes an outer cover storing a battery pack inside the outer cover, a flange provided outside a battery pack cover, and a flying object protection frame provided inside the outer cover. The flying object protection frame is provided outside the flange and at a different height from the flange.

According to the battery pack storage case of the present disclosure, even in the event of a collision with a flying object, contact with the battery module can be suppressed, thereby improving safety.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating an example of a battery pack storage case according to a first embodiment;

FIG. 2 is a cross-sectional view illustrating the example of the battery pack storage case according to the first embodiment; and

FIG. 3 is a cross-sectional view and a perspective view illustrating a part of the battery pack storage case according to the first embodiment.

### DETAILED DESCRIPTION OF EMBODIMENTS

### First Embodiment

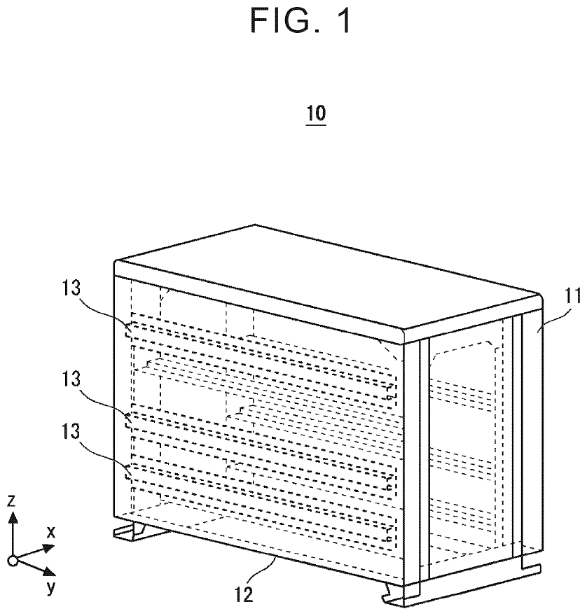

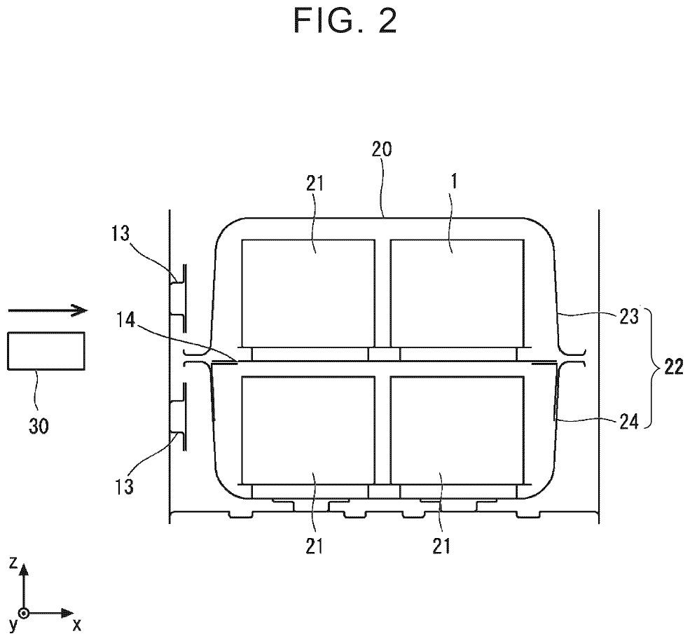

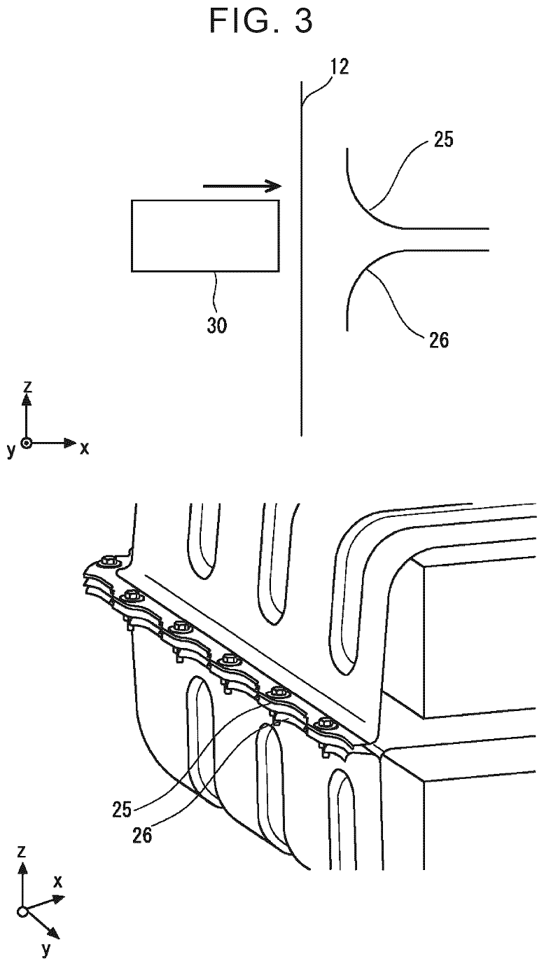

Hereinafter, an embodiment of the present disclosure will be described with reference to the drawings. FIG. 1 is a perspective view illustrating an example of a battery pack storage case according to a first embodiment. FIG. 2 is a cross-sectional view illustrating the example of the battery pack storage case according to the first embodiment. FIG. 3 is a cross-sectional view and a perspective view illustrating a part of the battery pack storage case according to the first embodiment.

In FIG. 1, a storage battery unit 10 includes a battery pack storage case 11 in its outermost portion, and a battery pack 20 is fixed inside the battery pack storage case 11.

The battery pack 20 has a sealed structure to suppress short circuits and the like caused by water entry. Note that in order to adjust the pressure inside the battery pack 20, a breathable membrane that is impermeable to water but permeable to air is attached. A reinforcement 14 that supports battery modules 21 and extends in an x direction is provided in the battery pack 20.

The battery pack storage case 11 includes an outer cover 12, flying object protection frames 13, and the reinforcement 14. The outer cover 12 stores the battery pack 20 therein. The outer cover 12 is preferably made of a metal, such as copper or aluminum.

In the battery pack 20, a battery is stored inside a battery pack cover 22. The battery pack cover 22 has a structure in which an upper cover (UPR cover) 23 and a lower case (LWR case) 24 are fastened together with a seal rubber (not shown) sandwiched therebetween. This structure ensures watertightness. In order to compress the seal rubber, the ends of flanges 25, 26 of the UPR cover 23 and the LWR case 24 are bent in directions away from the surface on which the seal rubber is sandwiched, thereby increasing surface rigidity.

The flying object protection frames 13 are provided inside the outer cover 12. The flying object protection frames 13 are provided outside the flanges 25, 26 and at different heights from the flanges 25, 26. The flying object protection frames 13 are preferably made of a metal, such as copper or aluminum.

The reinforcement 14 is a reinforcing material that supports the battery modules 21. The reinforcement 14 has a shape in which two or more plates are joined together by welding or the like. One of the plates of the reinforcement 14 is disposed in an xy-plane direction in FIG. 2. Another of the plates of the reinforcement 14 extends in a z direction in FIG. 2 and is connected to the LWR case 24. Furthermore, the reinforcement 14 is positioned at a height such that the reinforcement 14 is in the vicinity of the flanges 25, 26. The reinforcement 14 is preferably made of a metal, such as copper or aluminum.

In a case where a flying object 30 collides with the storage battery unit 10 due to strong winds, such as a typhoon, when the flying object 30 collides with the flying object protection frames 13, the flying object protection frames 13 protect the battery pack 20.

When the flying object 30 collides with a portion between two of the flying object protection frames 13, the flying object 30 does not collide directly with the flying object protection frames 13. Therefore, the battery pack 20 is protected by the rigidity of the outer cover 12 and the rigidity of the flying object protection frames 13.

When protection is still not possible, the surfaces of the bent flanges 25, 26 of the UPR cover 23 and the LWR case 24 absorb the impact.

Furthermore, since the reinforcement 14 in the battery pack 20 has a flat surface in the x direction, which is the same as the direction in which the flying object 30 comes, deformation of the battery pack 20 in the x direction can be suppressed.

Thus, according to the battery pack storage case of the first embodiment, even in the event of a collision with the flying object 30, contact with the battery modules can be suppressed, thereby improving safety.

Even when the storage battery unit 10 receives an impact locally, such as a collision with a flying object, damage to the battery modules can be reduced.

What is claimed is:

1. A battery pack storage case comprising:
a battery pack in which a battery module is stored inside a battery pack cover;
an outer cover storing the battery pack inside the outer cover;
a flange provided outside the battery pack cover; and
a flying object protection frame provided inside the outer cover, wherein the flying object protection frame is provided outside the flange and at a different height from the flange.

2. The battery pack storage case according to claim 1, wherein:
the battery pack cover includes an upper cover and a lower case; and
the upper cover and the lower case are fastened to each other with a seal rubber sandwiched between the upper cover and the lower case.

3. The battery pack storage case according to claim 2, wherein the flange of each of the upper cover and the lower case is bent.
